(19) United States
(12) Patent Application Publication
(10) Pub. No.: US 2006/0168030 A1
(43) Pub. Date: Jul. 27, 2006

(54) Anti-spam service

(75) Inventors: Yigang Cai, Naperville, IL (US); Shehryar S. Qutub, Hoffman Estates, IL (US); Alok Sharma, Lisle, IL (US)

Correspondence Address: WERNER ULRICH, 434 MAPLE STREET, GLEN ELLYN, IL, 60137-3826, US

(73) Assignee: Lucent Technologies, Inc.

(21) Appl. No.: 11/018,267

(22) Filed: Dec. 21, 2004

(51) Int. Cl. G06F 15/16

(52) U.S. Cl. 709/206

(57) ABSTRACT

In a telecommunications network, a method and apparatus for blocking unwanted messages (spam). A centralized anti-spam network server is used to access data for customized anti-spam services for individual networks and the source and destination terminals of a requested connection. The class of anti-spam service can include, for example, message subject or message content to allow particular types of messages to be blocked. Advantageously, the individual customers and individual networks can perform different levels and different types of spam filtration to meet their needs.

### RELATED APPLICATION(S)

This application is related to the applications of:

Yigang Cai, Shehryar S. Qutub, and Alok Sharma entitled “Storing Anti-Spam Black Lists”;

Yigang Cal, Shehryar S. Qutub, and Alok Sharma entitled “Anti-Spam Server”;

Yigang Cal, Shehryar S. Qutub, and Alok Sharma entitled “Detection Of Unwanted Messages (Spam)”;

Yigang Cai, Shehryar S. Qutub, and Alok Sharma entitled “Unwanted Message (Spam) Detection Based On Message Content”;

Yigang Cai, Shehryar S. Qutub, Gyan Shanker, and Alok Sharma entitled “Spam Checking For Internetwork Messages”; and

Yigang Cai, Shehryar S. Qutub, and Alok Sharma entitled “Spam White List”;

which applications are assigned to the assignee of the present application and are being filed on an even date herewith.

### TECHNICAL FIELD

This invention relates to methods and apparatus for blocking unwanted messages (spam) in a telecommunications network and more specifically for providing different levels of spam message blocking.

### BACKGROUND OF THE INVENTION

With the advent of the Internet, it has become easy to send messages to a large number of destinations at little or no cost to the sender. The messages include the short messages of short message service. These messages include unsolicited and unwanted messages (spam) which are a nuisance to the receiver of the message who has to clear the message and determine whether it is of any importance. Further, they are a nuisance to the carrier of the telecommunications network used for transmitting the message, not only because they present a customer relations problem with respect to irate customers who are flooded with spam, but also because these messages, for which there is usually little or no revenue, use network resources. An illustration of the seriousness of this problem is given by the following two statistics. In China in 2003, two trillion short message service (SMS) messages were sent over the Chinese telecommunications network; of these messages, an estimated three quarters were spam messages. The second statistics is that in the United States an estimated 85-90% of e-mail messages are spam.

A number of arrangements have been proposed and many implemented for cutting down on the number of delivered spam messages. Various arrangements have been proposed for analyzing messages prior to delivering them. According to one arrangement, if the calling party is not one of a pre-selected group specified by the called party, the message is blocked. Spam messages can also be intercepted by permitting a called party to specify that no messages destined for more than N destinations are to be delivered.

A called party can refuse to publicize his/her telephone number or e-mail address. In addition to the obvious disadvantages of not allowing callers to look up the telephone number or e-mail address of the called party, such arrangements are likely to be ineffective. An unlisted e-mail address can be detected by a sophisticated backer from the IP network, for example, by monitoring message headers at a router. An unlisted called number simply invites the caller to send messages to all 10,000 telephone numbers of an office code; as mentioned above, this is very easy with present arrangements for sending messages to a plurality of destinations.

The blocking of spam messages can consume substantial telecommunications network and processing resources. A balance must be maintained between allowing too many spam messages to be sent and processing too many messages in order to intercept almost all spam messages.

### SUMMARY OF THE INVENTION

Applicants have carefully studied this problem and have recognized, inventively, that an across the board solution may not be appropriate. Some users are very tolerant of receiving many spam messages while others would gladly pay a substantial premium to have almost all spam messages intercepted. Similarly, some network carriers are more anxious than others to protect their customers from spam.

Applicants have made a contribution over the teachings of the prior art in accordance with their invention wherein telecommunications networks and individual customers are provided with options for different levels of service in the interception and blocking of spam messages; an anti-spam network server system includes a database for storing a network class of service and individual customer classes of service for intercepting spam messages. For example, one network operator may choose only to provide black lists of sources from which it will not transmit messages while another can, additionally, analyze content of messages from other sources in order to filter out, for example, obscene messages. Similarly, individual customers may choose to accept any message which its serving network will accept or may require an additional black list or additional content filtering. Presumably, a customer who requires additional spam filtering would pay for this service. The additional spam filtering provided by the network might give the providing network a competitive advantage in attracting customers. Filtering spam messages can remove unwanted traffic, both directly and by discouraging spam transmitters; this can improve the performance of the network. On the other hand, an anti-spam process may delay transmission of suspect messages. Advantageously, Applicants' arrangement permits individual users and individual networks to tailor an anti-spam system to fit their needs.

An anti-spam network server can serve a single network or a plurality of networks, including networks in different countries. Advantageously, if the server serves a plurality of networks, the detection of spam can take into account data from a source and a destination network, including the classes of anti-spam service of the source customer, source network, destination customer and destination network.

### BRIEF DESCRIPTION OF THE DRAWING(S)

FIG. 1 is a block diagram illustrating the configuration of Applicants' invention.

### DETAILED DESCRIPTION

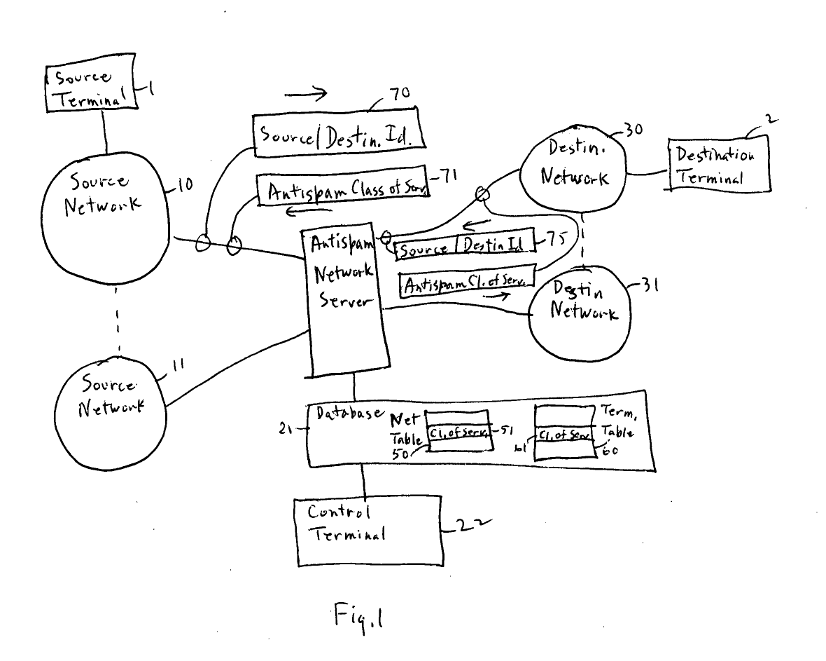

FIG. 1 is a block diagram illustrating the configuration of Applicants' invention. A source terminal wishes to send a message or establish a connection to a destination terminal. The source terminal is connected to a source network 10 and the destination terminal is connected to a destination network 30. There can be a plurality of source networks 10, . . . , 11 and a plurality of destination networks 30, . . . , 31. It is to be understood that the source network and destination network (shown herein) are the source and destination for a particular message; both source networks and destination networks can act as destination and source networks on other calls. In addition, many calls are for intra-network connections, wherein the source and destination networks are the same.

The source and destination networks are interconnected by connection paths (not shown). All the source and destination networks are connected by signaling links to an anti-spam network server 20. This server has an associated database 21 for access by the server 20. The database also can be accessed by control terminals of the operators of the various networks; only one such control terminal 22 is shown. The control terminals are for updating entries in database 20. Database 20 includes a network table 50 with entries for each of the networks served by the network server including entry 51 for source network 10. The database also includes one or more terminal tables 60 which store a class of service for individual destination terminals such as entry 61 for destination terminal 2.

Assume there is a request to send a message from source terminal 1 to destination terminal 2. Source network 10 sends a request message 70 including the source/destination identification to the anti-spam network server 20. The destination identification includes the destination network identification previously derived by the source network 10. The anti-spam network server checks the network table 50 to find the class of service of anti-spam actions of source network 10 and the class of anti-spam actions required for destination terminal 2. The anti-spam network server returns a message 71 to the source network 10 reporting the types of anti-spam processing required for this message. The source network 10 performs those anti-spam actions which it is equipped to process and sends the message, along with an indication of the types of anti-spam actions performed, to the destination network 30. The destination network 30 then sends its own inquiry to the anti-spam network server 20, message 75, and receives a response in message 76. The destination network 30 then performs any additional anti-spam actions which have not yet been performed by source network 10. Messages which pass these anti-spam actions are then sent to the destination terminal 2.

For the case in which the anti-spam network server serves a plurality of networks, a class of service can be provided for each network pair. Then the specified network spam check is performed for all communications between the two networks. Alternatively, a class of service can be stored for each network and the more severe checks indicated by the two classes of service of the networks used in a connection are performed. Revenue sharing agreements can be used to help allocate costs of the server to each network.

The class of service for anti-spam checks is quite broad. Among the kinds of checks are the following.

1. Message source validation. This includes the message source identity check such as that performed by black lists and white lists. (Note that entries in a source network's white list whose associated messages would then be passed might not be on a white list of the destination network which would then have to perform additional checks.) Also included under source validation are type validation wherein, for example, a particular source may only be allowed to send certain message types such as short message service (SMS), mobile message service (MMS), sender types (a message from a foreign network may be blocked). The sender's address (calling party number) is checked since it is relatively easy for a spammer to fake an address in the SMS, MMS or e-mail header.

2. Destination validation: message destination identity check (white/black lists); message destination versus message type validation (for example, a destination may only be allowed to receive certain message types); receiver types (messages may only be sent to a receiver in a home network); receiver device types (certain types of messages should not be sent to certain types of receiver equipment because the user of the receiver device may not wish to receive certain classes of messages, e.g., simple messages on a complex high-usage terminal, or an audio message for a video capable terminal). If the receiver is incompatible, the message won't go through anyway. [One example, a subscriber has a fancy cell phone which is able to receive multimedia messages, but for money saving, he/she may set up the criteria that he/she only receive multimedia messages from home network. Another example, video stream is barred to send to handset even it has capability to receive it, but video stream is allowed to send to laptop. You may describe it in a broad way.]

3. Message screening, message types (SMS, MMS, e-mail, Internet messages); service types, (e-commerce, weather service, stock information, sports broadcasting); content types (text, audio clips, audio streaming); subject matching; content pattern matching (text/audio); languages.

4. Traffic threshold. (Maximum limit in a given period: network traffic volume control; sending network volume threshold control; individual sender volume threshold control; receiver adjacency factor check (e.g., receivers may reject messages from a range of transmitter numbers).

5. Spam filtering rule sets: rule engine supported spam filtering. For example:

```
IF Source_Network = “inter-network” AND Message_Type = “MMS”
AND Receiver_Device_Allowed = “Text Message”
THEN
    Block the message from the sender
    Send the response message to source network indicating not matching
of receive device
ENDIF
```

This rule rejects internetwork MMS text messages.

6. Bandwidth shaping: network with many detected spam messages narrows the bandwidth of good messages to a destination.

7. Automatic quick and deep spam analysis, i.e., rejection only of messages whose spam characteristic is detected by a rapid check.

All anti-spam services listed above can be tailored into different levels, i.e., classes of anti-spam services. Each class of services may include certain anti-spam services and sub-services. Each class of services will map to quality of service to satisfy the needs of the network operator or end user.

The above are examples of anti-spam services which can be invoked using a class of service stored in the anti-spam network server. However, any anti-spam service can be invoked or limited using the class of service stored at the anti-spam network server and the anti-span service can be provided in either the source network or the destination network.

The above description is of one preferred embodiment of Applicants' invention. Other embodiments will be apparent to those of ordinary skill in the art without departing from the scope of the invention. The invention is limited only by the attached claims.

We claim:

1. In a telecommunications network a method of providing for the blocking of unwanted communications (spam) tailored to the needs of an individual customer comprising the steps of:
responsive to receipt of a connection request to said individual customer, requesting information concerning said request from an anti-spam network server;
said anti-spam network server responsive to said request determining a class of anti-spam processing actions to be performed for the connection specified by said request;
performing the anti-spam actions specified by said server on said requested connection prior to completing said connection; and
blocking said connection if the result of said anti-spam processing actions indicate that the requested message is to be treated as spam.

2. The method of claim 1 further comprising the steps of:
determining anti-spam processing actions to be performed for communications terminating on a destination network serving said individual customer; and
performing any additional anti-spam processing actions required by said destination network.

3. The method of claim 1 further comprising the steps of:
determining anti-spam processing actions to be performed for communications originating on an originating network serving a caller of said connection; and
performing any additional anti-spam processing actions required by said originating network.

4. In a telecommunications network, apparatus for providing for the blocking of unwanted communications (spam) tailored to the needs of an individual customer, comprising:
means, responsive to receipt of a connection request to said individual customer, for requesting information concerning said request from an anti-spam network server;
said anti-spam network server responsive to said request determining a class of anti-spam processing actions to be performed for the connection specified by said request;
means for performing the anti-spam actions specified by said server on said requested connection prior to completing said connection; and
means for blocking said connection if the result of said anti-spam processing actions indicate that the requested message is to be treated as spam.

5. The apparatus of claim 4, further comprising:
means for determining anti-spam processing actions to be performed for communications terminating on a destination network serving said individual customer; and
means for performing any additional anti-spam processing actions required by said destination network.

6. The apparatus of claim 4, further comprising:
means for determining anti-spam processing actions to be performed for communications originating on an originating network serving a caller of said connection; and
means for performing any additional anti-spam processing actions required by said originating network.
